(19) United States
(12) Patent Application Publication
(10) Pub. No.: US 2013/0177820 A1
(43) Pub. Date: Jul. 11, 2013

(54) SILICON-CONTAINING COMPOSITIONS, METHODS OF THEIR PREPARATION, AND METHODS OF ELECTROLYTICALLY DEPOSITING SILICON ON A CURRENT CARRIER FOR USE IN LITHIUM ION BATTERY APPLICATIONS

(71) Applicants: PRASHANT NAGESH KUMTA, PITTSBURGH, PA (US); RIGVED EPUR, PITTSBURGH, PA (US); AYYAKKANNU MANIVANNAN, MORGANTOWN, WV (US)

(72) Inventors: PRASHANT NAGESH KUMTA, PITTSBURGH, PA (US); RIGVED EPUR, PITTSBURGH, PA (US); AYYAKKANNU MANIVANNAN, MORGANTOWN, WV (US)

(73) Assignee: UNIVERSITY OF PITTSBURGH - OF THE COMMONWEALTH SYSTEMS OF HIGHER EDUCATION, PITTSBURGH, PA (US)

(21) Appl. No.: 13/733,992

(22) Filed: Jan. 4, 2013

Related U.S. Application Data
(60) Provisional application No. 61/583,770, filed on Jan. 6, 2012.

(51) Int. Cl. H01M 4/134; H01M 10/0564; H01M 4/04; H01M 10/0525

(52) U.S. Cl. CPC H01M 4/134; H01M 10/0525; H01M 10/0564; H01M 4/0402
USPC 429/306; 429/218.1; 429/231.8; 205/316; 252/500

(57) ABSTRACT

The invention relates to silicon-containing compositions, methods of preparing these compositions and methods of depositing amorphous silicon originating from these compositions onto substrates to form composites for use, for example, as anodes in lithium ion batteries. An amorphous silicon-containing coating, such as a thin film, is formed on the substrate. The coating can further include carbon and crystalline silicon.

### CROSS-REFERENCE TO RELATED APPLICATIONS

This patent application claims the benefit of U.S. Provisional Patent Application Ser. No. 61/583,770 filed on Jan. 6, 2012, and entitled “Novel Low Cost Electrodeposition Approaches to Amorphous Silicon and Silicon-Carbon Composites for Lithium-Ion Anodes”.

### GOVERNMENT FUNDING

This invention was made with government support under grant number DE-ACO2-05CHII231 awarded by the Department of Energy.

### 1. FIELD OF THE INVENTION

The invention relates to silicon-containing compositions, methods of preparing the compositions and methods of electrolytically depositing silicon on a substrate, e.g., current carrier, for use in lithium ion battery.

### 2. BACKGROUND

It is known in the art to use lithium ion batteries for a wide variety of energy storage applications. Due to their very high energy density and flexible design, lithium ion batteries have become a workhorse to power consumer electronic devices and they have made a pronounced entry into the automobile market in the form of electric vehicle and hybrid electric vehicles.

Carbon, such as carbon graphite, is commonly employed in producing lithium ion batteries. Graphite has a theoretical capacity of 372 mAh g⁻¹ and is a widely used commercial anode for portable lithium ion-based battery systems. In order to accommodate the proliferating needs of energy storage device applications, such as electric vehicles and grid energy, it is desired to develop batteries with higher energy density, good cyclability and improved rate capability.

In considering alternative materials for use in producing lithium ion batteries, it is acknowledged that silicon has a theoretical capacity of 4212 mAh g⁻¹ and therefore, may be an acceptable anode capable of storing nearly 10 times more energy than that of graphite.

However, it is recognized that upon cycling, large volumetric changes (e.g., >300%) occur during lithium alloying and de-alloying with crystalline silicon. This may lead to mechanical pulverization of the material and consequently, loss of inter-particle contact and contact with the current collector. This contact loss can be catastrophic as it may result in rapid capacity fade and battery failure.

In an attempt to address the issue of mechanical failure in silicon-based anodes, amorphous forms and nanostructured forms of silicon, such as nanoparticles, nanowires and nanotubes, have been synthesized in the art. The nanostructured forms provide mechanical integrity without pulverization and better electronic conductivity which may result in improved capacity retention and cycle life. In amorphous silicon, due to the presence of defects and absence of long range order, the volume expansion upon lithium insertion is homogenous and less catastrophic compared to crystalline silicon. Thus, the amount of pulverization of the active material is significantly reduced which may lead to enhanced capacity retention and cyclability.

Amorphous silicon is generally made by physical and chemical vapor deposition methods. Physical vapor deposition methods include radio frequency (RF) or magnetron sputtering and pulsed layer deposition using silicon targets. Chemical vapor deposition methods include thermal, microwave or plasma assisted decomposition of silicon precursors, such as silane. These techniques are, however, complicated and costly because they require expensive equipment and well trained personnel.

Electrodeposition is a simple and inexpensive known technique which has been used extensively in industrial applications, such as in plating processes to modify the surface properties of metals and alloys in order to improve their corrosion resistance.

There is room for improvement in identifying anode materials for use in lithium ion battery applications, as well as for developing processes to prepare these materials. Thus, the invention relates to a simple, cost-effective method of making silicon-containing compositions and electrolytically depositing silicon originating from silicon halide on a substrate, such as a current carrier, to form a composite for use as an anode in a lithium ion battery.

The invention allows the silicon to be electrolytically deposited and directly used as an anode without the presence of other additives, such as a conductive agent and a binder. Thus, the additional interfaces and weight associated with conventional electrode preparation can be eliminated. The elimination of these materials results in a simpler and more facile manufacturing process.

### SUMMARY OF THE INVENTION

In one aspect, the invention provides an anode composite including a substrate having a surface and a coating electrolytically deposited directly onto the surface. The coating includes amorphous silicon. The amorphous silicon originates from a silicon-containing composition which includes silicon halide and solvent. The silicon halide can be selected from the group consisting of silicon tetrahydrochloride, silicon chloride hydride, silicon tetrabromide, silicon tetraiodide and mixtures thereof. The solvent can be selected from the group consisting of propylene carbonate, silicon tetrachloride, acetonitrile, tetrahydrofuran and mixtures thereof. The substrate can include a current carrier and the current carrier can include a material selected from the group consisting of copper, nickel, platinum, quartz, gold, stainless steel, tantalum, titanium, silver, and mixtures thereof.

Further, the silicon-containing composition can include a supporting electrolyte. The supporting electrolyte can be selected from the group consisting of tetraethylammonium chloride, tetrabutylammonium chloride, tetrabutylammonium perchlorate and mixtures thereof.

Furthermore, the coating can be in the form of a thin film

The coating can further include carbon and the carbon can be selected from the group consisting of carbon nanotubes, graphene, elemental carbon and mixtures thereof. The coating can also include silicon selected from the group consisting of crystalline silicon, nanocrystalline silicon and mixtures thereof.

In another aspect, the invention provides a silicon-containing composition for electrolytic deposition of amorphous silicon therefrom on a surface of a substrate. The composition includes silicon halide, solvent and a supporting electrolyte. The composition provides an electrical conductivity to reduce said silicon halide upon passing an electrolyzing current through said composition.

In another aspect, the invention provides a method for electrolytically depositing on the surface of the substrate, the amorphous silicon originating from the silicon-containing composition. The method includes obtaining the substrate, preparing the silicon-containing composition including silicon halide, solvent and supporting electrolyte, employing the silicon-containing composition as a solute in an electrolytic deposition, and forming a coating comprising the amorphous silicon on the surface of the substrate.

In another aspect, the invention provides a method for preparing the anode composite. The method includes obtaining the substrate, preparing the silicon-containing composition including the silicon halide and the solvent, employing the silicon-containing composition as a solute in an electrolytic deposition, and forming the coating comprising the amorphous silicon on the surface of the substrate.

In another aspect, the invention provides a method for preparing an anode. The method includes obtaining a substrate, preparing a silicon-containing composition including silicon halide and solvent, employing the silicon-containing composition as a solute in an electrolytic deposition, forming a coating containing amorphous silicon on the substrate.

In another aspect, the invention provides an electrode including the anode composite. The electrode can include the absence of material selected from the group consisting of binders, conducting agents and mixtures thereof.

In yet another aspect, the invention provides a rechargeable lithium-ion battery including the anode composite.

### BRIEF DESCRIPTION OF THE DRAWINGS

The invention is further illustrated by the following drawings, in which:

FIG. 1 is a plot of the linear sweep voltammograms of copper foil in the electrolyte with and without SiCl₄ at a scan rate of 10 mVs-1, in accordance with certain embodiments of the invention;

FIG. 2 is a plot of the chronopotentiogram for SiCl₄ reduction on copper at −1 mA cm-2 for one hour, in accordance with certain embodiments of the invention;

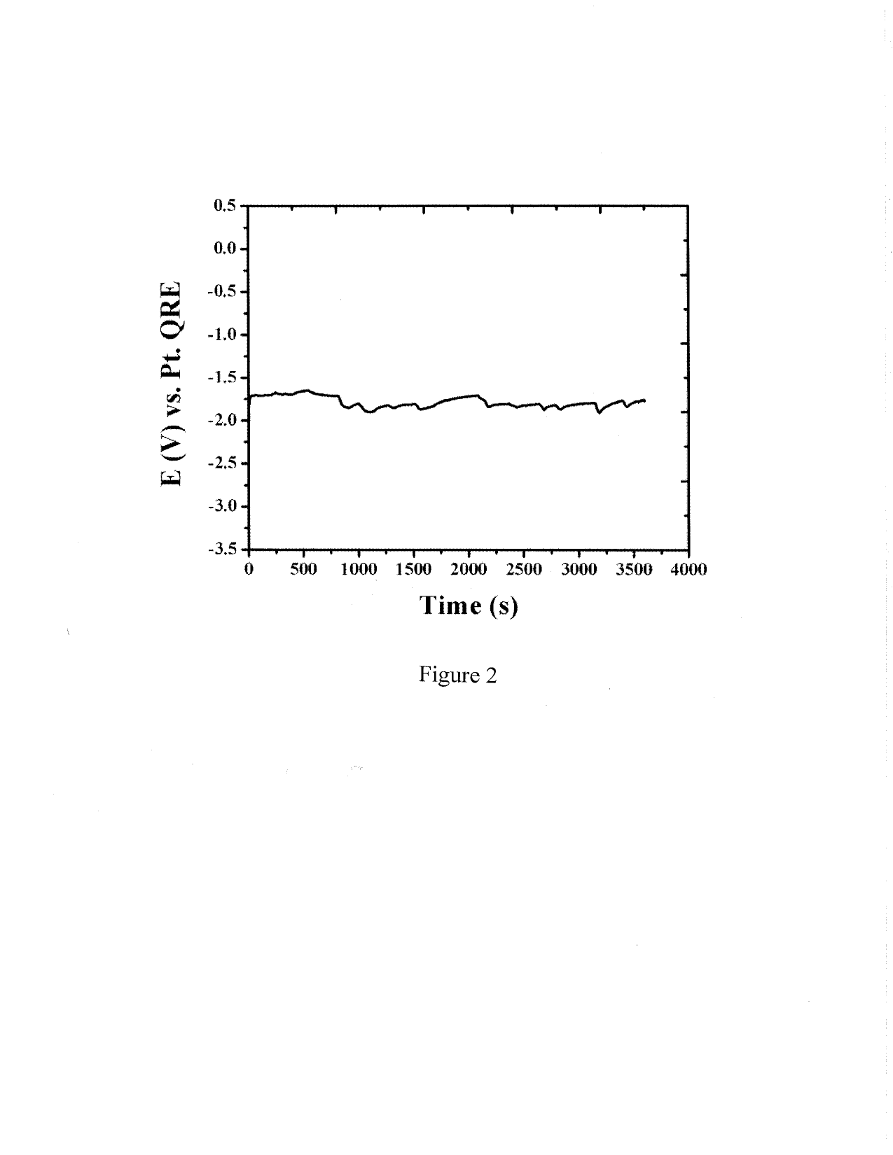

FIG. 3 is a plot of raman spectra of the electrodeposited silicon using 633 nm red laser, in accordance with certain embodiments of the invention;

FIG. 4 is an EDAX spectra of the electrodeposited film after 1 hour of galvanostatic reduction at −1 mA cm-2, in accordance with certain embodiments of the invention;

FIG. 5 is a plot of the charge/discharge profile of electrodeposited silicon cycled at 400 mAg-1, in accordance with certain embodiments of the invention;

FIG. 6 is a plot of differential capacity versus voltage for the electrodeposited films at the end of 1^{st} and 2^{nd} cycles, in accordance with certain embodiments of the invention;

FIG. 7 is a plot of the capacity and columbic efficiency cycled at 400 mAg-1 between 1.2 to 0.02 V for 100 cycles, in accordance with certain embodiments of the invention; and

FIG. 8 is a plot of rate capability test performed on the deposited films at C/4, C/2, 1 C, 2 C and 4 C rates, in accordance with certain embodiments of the invention.

### DETAILED DESCRIPTION OF PREFERRED EMBODIMENTS

The invention relates to silicon-containing compositions for use in the electrolytic deposition of amorphous silicon on a substrate, such as a current carrier. The invention also relates to methods of preparing these compositions and methods of electrolytically depositing the amorphous silicon on the substrate. Further, the invention relates to composites including the substrate and the amorphous silicon deposited thereon, and methods of preparing the composites. Moreover, the invention relates to anodes for use in lithium ion batteries and methods for preparing the anodes. In the invention, the amorphous silicon which is electrolytically deposited on the substrate originates from silicon halide. The amorphous silicon can be electrolytically deposited directly on the substrate and thus, there may be an absence of conventional binders and/or conducting agents on the surface of the substrate.

As is known in the art, silicon is not found in nature as a free element but instead occurs in various minerals, such as silica and silicates. As a result, it is necessary to process, e.g., electrolytically reduce, silica and silicates to obtain elemental silicon. In the invention, silicon for the electrolytic deposition on a substrate originates from silicon halide. Silicon halide is present in the silicon-containing compositions of the invention. A variety of silicon halides are known in the art and suitable silicon halides for use in the invention include silicon tetrahydrochloride (SiCl₄), silicon chloride hydride (SiHCl₃), silicon tetrabromide (SiBr₄), silicon tetraiodide (SiI₄) and mixtures thereof. In certain embodiments, the silicon halide is SiCl₄.

In addition to silicon halide, the silicon-containing compositions of the invention include solvent. Suitable solvents include those known in the art and commonly used for electrodeposition of silicon-containing materials, such as organic solvents which include covalent carbon to hydrogen linkages. In certain embodiments, suitable organic solvents for use in the invention are substantially anhydrous or essentially free from water to avoid any significant reaction with the silicon halide present in the silicon-containing composition. Further, useful solvents may be aprotic in that they neither lose a proton to nor gain a proton from the particular silicon halide present in the silicon-containing composition. Furthermore, it is preferred that the solvent is stable and does not decompose or degrade at the reaction potentials employed during the electrolytic deposition. In certain embodiments, the solvent has a relatively high dielectric constant such that, for example, if there is an adduct that forms between the solvent and the silicon halide, the dielectric constant is sufficiently high for dissociation of an ion pair constituting the adduct. Non-limiting examples of suitable solvents for use in the invention include propylene carbonate, silicon tetrachloride, acetonitrile, tetrahydrofuran and mixtures thereof.

The silicon-containing composition of the invention can also include a supporting electrolyte. In general, non-aqueous electrolytes may have poor conductivity and therefore, supporting electrolytes which are non-reactive ionic species or salts may be used to improve their ionic conductivity, decrease cell resistance and maintain uniform current density. Non-limiting examples of supporting electrolytes for use in the invention include those which are commonly used for electrodeposition of silicon, such as but not limited to tetraethylammonium chloride (TEACL), tetrabutylammonium chloride (TBACL), tetrabutylammonium perchlorate (TBACLO) and the like, and mixtures thereof.

The silicon-containing composition is prepared by combining the silicon halide, solvent and optionally supporting electrolyte. This can be performed at room temperature and atmospheric pressure. The silicon halide and optionally supporting electrolyte substantially dissolve in the solvent.

In the invention, the silicon-containing composition is employed in a conventional electrolyte deposition technique. For example, an electrolyzing current is passed through the silicon-containing composition which acts as a solute and as a result, amorphous silicon is electrolyically reduced and deposited on the surface of an electrically conductive substrate. The substrate can be made up of a wide variety of electrically conductive materials known in the art. In certain embodiments, the substrate can include a current carrier. Without intending to be bound by any particular theory, it is believed that the current carrier (or charge collector) is a structure within an electrode (such as a battery electrode) that provides a path for an electric current to or from the active material. Suitable substrates for use in the invention can include, but are not limited to, for example, quartz, nickel, platinum, silver, gold, copper, stainless steel, tantalum, titanium, Inconel, and mixtures thereof. In certain embodiments, the substrate includes copper. Copper is a relatively inexpensive material and therefore, may produce a low cost composite for use, for example, in a lithium ion battery, in accordance with the invention.

In certain embodiments, the coated substrate can form a composite. In other embodiments, the coated substrate can form an anode for use, for example, in a lithium ion battery.

A wide variety of conventional electrodeposition techniques and conditions known in the art can be employed in the invention. For example, in accordance with certain embodiments of the invention, the amorphous silicon originating from the silicon halide present in the silicon-containing composition can be electrodeposited on an electrically conductive cathode body at convenient temperatures, e.g., room temperature, and pressures, e.g., atmospheric pressure, by passing an electrolyzing current through the silicon-containing composition. In certain other embodiments, the electrodepositing can be carried out with the silicon-containing composition under cover of an inert gas, e.g., argon, at a temperature between about 20° C. and 100° C., and a pressure which is approximately slightly above atmospheric pressure.

Further, conventional electrodeposition apparatus known in the art can be employed in the invention. For example, the silicon-containing composition of the invention can be disposed as a solute within any suitably sized and shaped vessel. The vessel is of a nonconductive material which is nonreactive with the silicon-containing composition and may be quartz, silica, glass, polytetrafluoroethylene, polychlorotrifluoroethylene and the like. The vessel is hermetically sealable and generally includes a partition therein to separate the vessel into two compartments. The partition is of any suitable nonconducting and nonreactive material, and is nonpervious to the silicon-containing composition and inert gases and halogen gases. One compartment of the vessel contains the anode. The other compartment contains the cathode. The volume of the vessel above the composition is typically filled with a dry inert gas, such as argon, helium, nitrogen and the like. The vessel can include a venting release gas valve to control and regulate gas pressure within the compartments. The silicon-containing composition within the vessel can be heated to a desired plating temperature or can be maintained at room temperature. An electrical conductor surrounded by, for example, polytetrafluoroethylene insulation can lead from each of the cathode and the anode, and a voltmeter may be connected thereto to measure potential between the anode and cathode. The conductor may be connected to an ammeter in order to measure the electrical current. Further, the conductor can lead to a power supply. The power supply has its negative terminal leading to the cathode and generally permits electrodeposition at potentiostatic conditions of a constant or varied cathode potential, as desired, and at galvanostatic conditions of a constant or varied electrolysis current, as desired.

As a result of electrodeposition, a coating containing amorphous silicon is formed on the substrate. The coating can be in the form of a film. The thickness of the film can vary. In general, it is known in the art to form a thin film on the substrate. In certain embodiments, the thickness of the film can vary from about 50 nm to about 100 microns.

Following electrodeposition, the substrate may be thoroughly rinsed in solvent, such as, for example, propylene carbonate or a mixture of propylene carbonate and acetone, to remove any traces of the silicon halide and unwanted impurities. The substrate may then be allowed to dry in a chamber, such as, for example, an argon-filled box.

It is contemplated that silicon can be controlled to form crystalline and nanocrystalline silicon on the substrate by varying the deposition temperature. Thus, in certain embodiments, the amorphous silicon-containing coating may include crystalline and/or nanocrystalline silicon.

In the invention the silicon-containing coating is fabricated directly onto the substrate in the absence of other materials, such as, binders and conductive agents. In the art, it is typical for electrodes for a lithium ion battery to be manufactured by slurry coating of an active material along with electrochemically inactive materials, such as binders and conductive substrates. These inactive materials contribute to the dead weight of the battery and make the manufacturing more complicated and time-consuming.

In certain embodiments, the substrate for use in the invention can include carbon. The carbon can be in various forms and suitable forms for use in the invention include carbon nanotubes, nanowires and nanorods, graphene, elemental carbon and mixtures thereof. The carbon can be deposited onto the substrate, e.g., current carrier, using conventional techniques known in the art. Thus, in certain embodiments, the substrate, e.g., composite, can include a combination of amorphous silicon, crystalline silicon, nanocrystalline silicon, and carbon nanotubes deposited thereon. The ratio of silicon to carbon can vary. In certain embodiments, the silicon to carbon ratio can be from 4:1 to 0.5:1.

The compositional, morphological and structural characterizations can be performed on the deposited films using known techniques and equipment such as scanning electron microscopy (SEM) and raman spectroscopy. In certain embodiments, the deposited films formed in accordance with the invention show a reversible capacity of approximately 1300 mAh/g with excellent columbic efficiency of greater than 99.5% for up to 100 cycles.

Further, the deposited films formed in accordance with the invention can be subjected to impedance studies at the end of charge of various cycles to assess their cyclability. In certain embodiments, the deposited films show a non-variable charge transfer resistance which correlates to the excellent cyclability of the film which has no appreciable decrease in capacity over 100 cycles.

### EXAMPLES

All chemicals used for the following deposition experiments were purchased from Sigma Aldrich (St. Louis, Mo.). Propylene carbonate (PC, 99.9% anhydrous) and silicon tetrachloride (SiCl₄, 99.99%) were used without further purification. PC was selected as the solvent for SiCl₄ because of its high dielectric constant and good solubility for silicon halides. In order to improve the electrolyte's conductivity, tetrabutylammonium chloride (TBACL, >97%) was dried overnight at 100° C. in a vacuum and was added as a supporting electrolyte to the solvent. In a deposition, the electrolyte was made of 0.5M SiCl₄ and 0.1M TBACL dissolved in PC. All of the following deposition-based experiments were carried out in a cylindrical, three-electrode cell made of glass, sealed with teflon gaskets. Copper foil (Insulectro, approximately 18 μm thick) was used as the working electrode. Platinum wire (Φ=0.5 mm, 99.95%, alfa Aesar) and platinum foil (0.1 mm thick, 0.5×0.5 cm², 99.9%, Aldrich) were used as the reference and counter electrodes, respectively. The electrodes were sonicated in ethanol and acetone for 5 minutes and dried in air before use. Voltrammetric studies such as linear sweep voltammetry (LSV) and chronopotentiometry were conducted using EC Epsilon (Bioanalytical Systems, Inc) potentiostat. Impedance studies were conducted on VersaSTAT 3 (Ametek, Inc). After deposition, the copper foils were thoroughly rinsed in PC and anhydrous acetone separately, to remove any traces of the electrolyte and unwanted impurities. The foils were allowed to dry in an argon-filled glove box for approximately 1 hour before further characterizations were performed.

Morphological and compositional analysis of the deposited films was performed using scanning electron microscopy (SEM, Philips XL 30) and energy dispersive X-ray spectroscopy (EDAX, Philips XL 30). Raman spectroscopy was performed using Renishaw in-via Raman microscope using a 633 nm red laser to evaluate the vibrational and rotational modes of the deposited films.

To assess electrochemical characteristics, the electrodeposited copper foil was cut into circular discs of diameter 11 mm which served as the working electrode. A 2016 coin cell assembly in a half cell configuration was used by employing lithium (Li) foil as a counter electrode and 1M LiPF₆ in ethylene carbonate and di-ethyl carbonate (EC:DEC=1:2 by volume) as the electrolyte. The assembled cells were tested by cycling between the voltage range of 0.02 to 1.2 V vs. Li⁺/Li at a constant current density of 400 mA g⁻¹ with a minute rest between the charge/discharge cycles. Rate capability tests were performed at C/4, C/2, 1 C, 2 C and 4 C rates. Impedance studies were performed using VersaSTAT 3 (Ametek, Inc) in a frequency range of 50 KHz to 100 mHz with 10 mV amplitude of an AC stimulus and no applied voltage bias.

### Example 1

### Voltammetric and Galvanostatic Studies

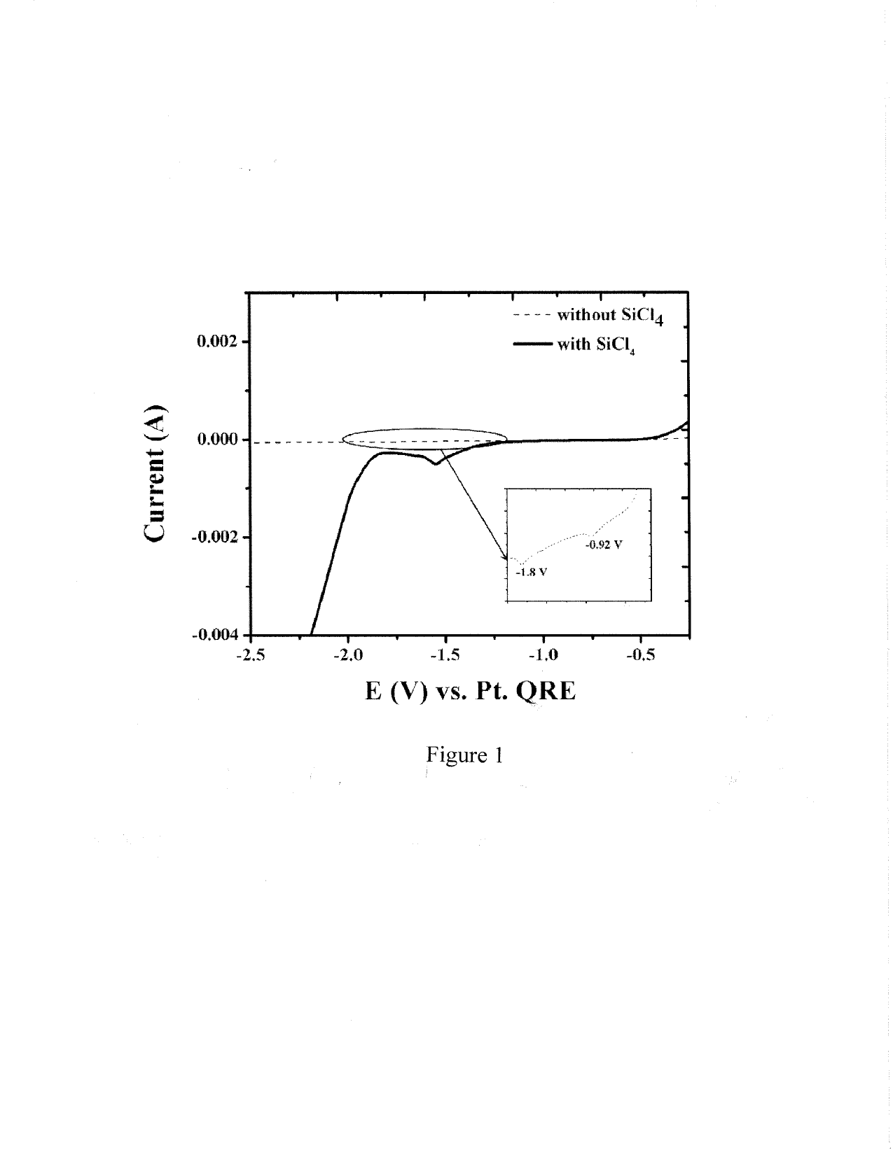

Linear sweep voltammograms (LSV) of copper foil in the electrolyte (PC and 0.1M TBACL) with and without the addition of SiCl₄ were recorded at a scan rate of 10 mV s⁻¹ as shown in FIG. 1. The LSV obtained for the solution containing the silicon precursor showed a cathodic peak at −1.6 V suggesting the reduction of SiCl₄. This was validated by the absence of a cathodic peak in LSV recorded for solvent and supporting electrolyte without the precursor. Also, two other small peaks were observed at −1.8 V and −0.92 V which may be from the reduction of tetrabutylammonium ion (supporting electrolyte) or trace amounts of H₂O and HCl present in the solvent and SiCl₄, respectively. Galvanostatic reduction was further performed by applying a current density of −1 mA cm⁻² for 1 hour. The reduction plateau observed at around −1.6 V validated the presence of a cathodic peak for Si obtained from the voltammetric studies.

### Example 2

### Raman Scattering

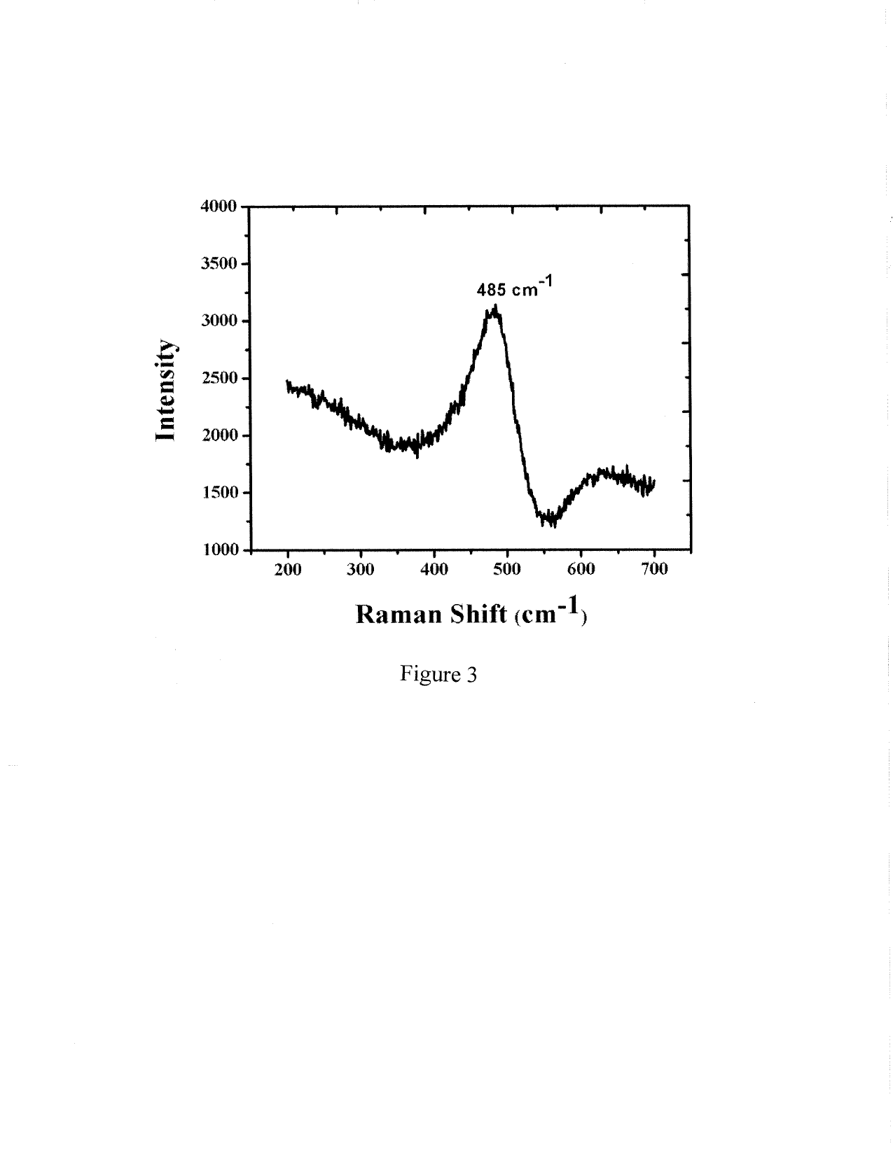

Soon after the galvanostatic deposition, the electrode was rinsed thoroughly in PC and anhydrous acetone for 5 minutes, after which it was left to dry in the glove box. A uniform yellowish green film was observed on the copper foil which when taken out of the glove box and exposed to atmosphere for an hour, turned grey due to the rapid oxidation of amorphous silicon to SiO₂. Therefore, characterizations such as raman spectroscopy and SEM were done within 30 minutes of the deposition. As shown in FIG. 3, raman spectra obtained from the electrodeposited region indicated a broad peak around 485 cm¹. For crystalline silicon, a sharp peak, attributed to the transverse optical (TO) vibrational mode, was reported to be present at 520 cm⁻¹. But, as the long range order was lost, the TO peak became broader and shifted to lower values of Raman shift. For the deposited films, no sharp peak at 520 cm⁻¹ was observed but a broader peak with peak position at 485 cm⁻¹ was found, which suggested that the deposited film was predominantly amorphous. However, some amount of nanocrystalline silicon could also be present apart from the amorphous content which was evident from the shape of the peak being not completely broad and the peak position centered at 485 cm⁻¹ instead of 480 cm⁻¹.

### Example 3

### SEM and EDAX

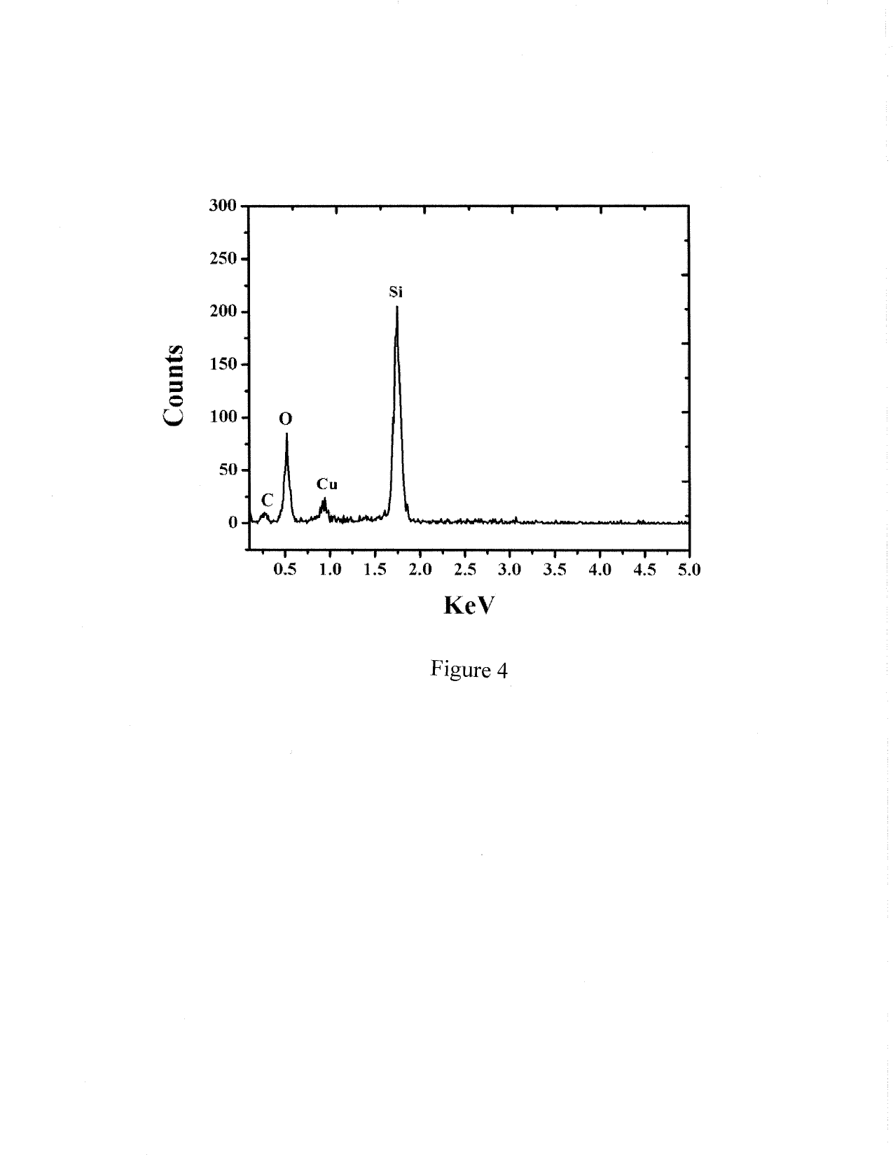

The SEM image of the silicon film electrodeposited on copper foil showed the presence of cracks with Si islands ranging from 10-20 μm. The EDAX analysis (see FIG. 4) indicated the presence of Si, C, O and Cu. The presence of oxygen was due to the surface oxidation upon exposure to atmospheric air while transferring the sample to the SEM chamber. Small amounts of carbon were also observed which may have been due to the presence of remnant solvent left behind after washing the electrode with PC and acetone. The copper peak may have been attributed to the background substrate onto which Si was electrodeposited.

### Example 4

### Electrochemical Characterization

The gravimetric capacity of the deposited silicon films was calculated based on the moles of silicon reduced following Faraday's law. However, the electrochemical reduction of SiCl₄ is accompanied by other side reactions such as solvent decomposition and reduction of tetrabutylammonium ion (TBA⁺) present in the electrolyte. Hence, an efficiency parameter, η, is introduced into Faraday's law to calculate the actual number of moles of silicon reduced. Based on previous experience with electrodeposition of silicon using similar electrolyte and deposition conditions, 35% (η=0.35) efficiency was used in this example.

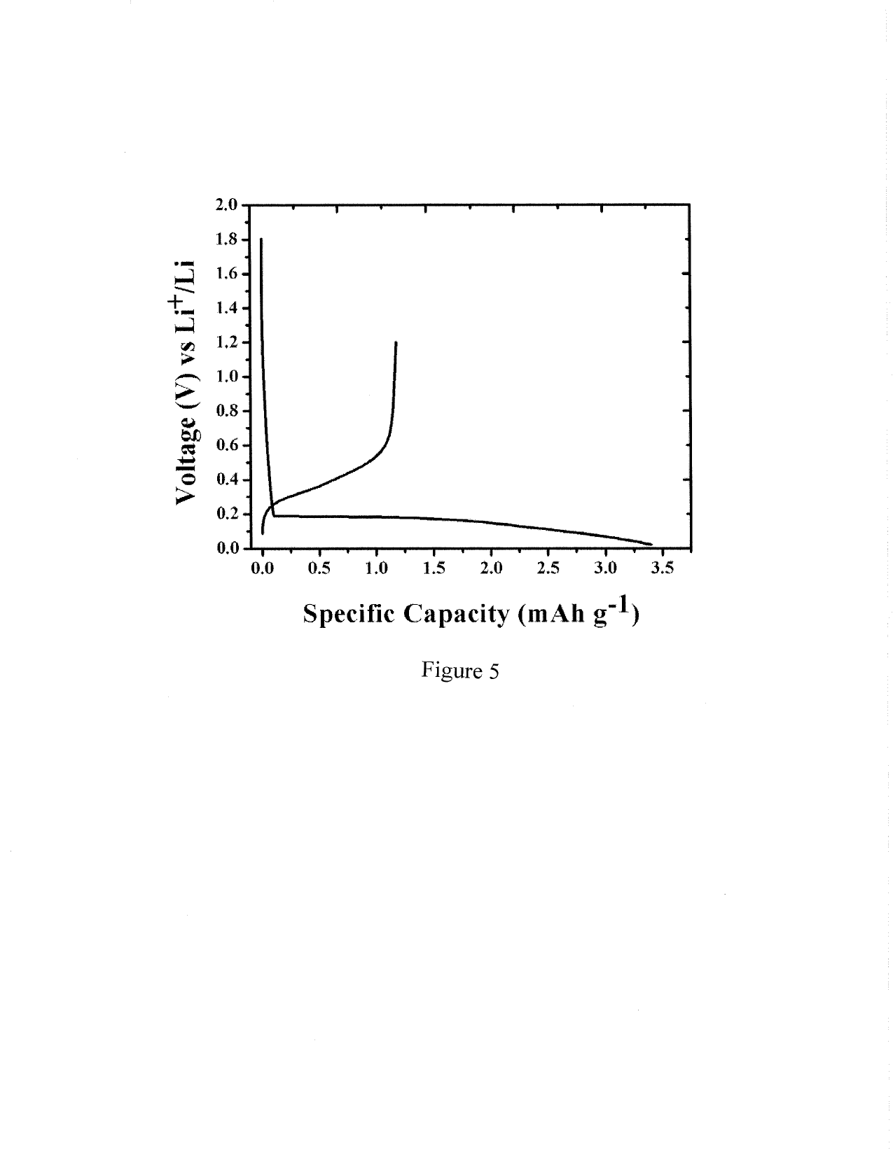

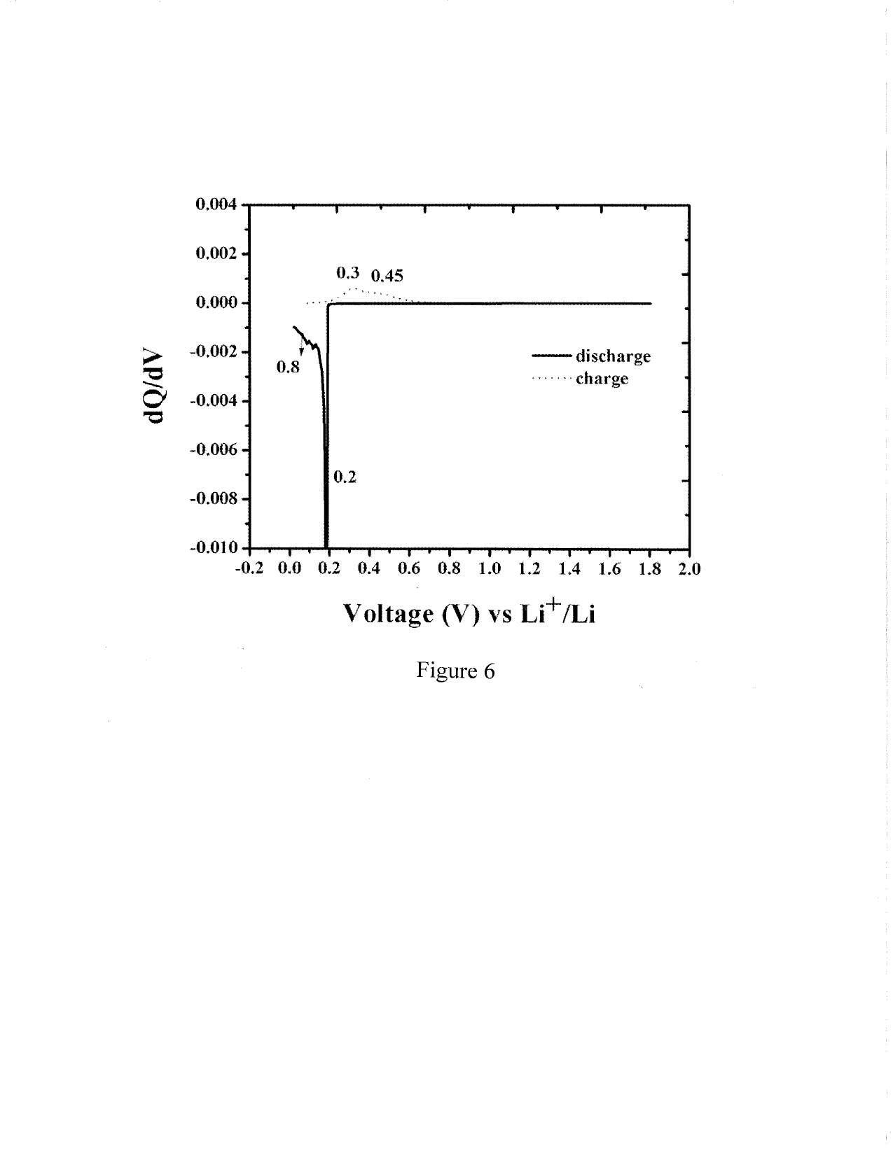

FIG. 5 shows the charge/discharge profiles for an applied current density of 400 mA g⁻¹ cycled between 1.2 to 0.02 V vs. Li⁺/Li of the electrodeposited silicon. First discharge and charge capacities of ˜3400 mAh g⁻¹ and ˜1150 mAh g⁻¹, respectively, were obtained with an irreversible loss of approximately 60%. Significant alloying could be observed at approximately 0.2 V (see FIG. 5) for the first discharge cycle which suggested the presence of a two phase region and transformation of any crystalline (or nanocrystalline) silicon present to an amorphous phase. This was confirmed by the presence of a large peak close to 0.2 V in the differential capacity plot (see FIG. 6). Other reactions could also be seen until approximately 0.08 V (see FIG. 6) which may have been attributed to the transition between the formations of various LiₓSi alloys. During the charge cycle, lithium may be extracted from silicon at approximately 0.3 V and approximately 0.45 V which is commonly observed for de-lithiation from amorphous alloys of LiₓSi.

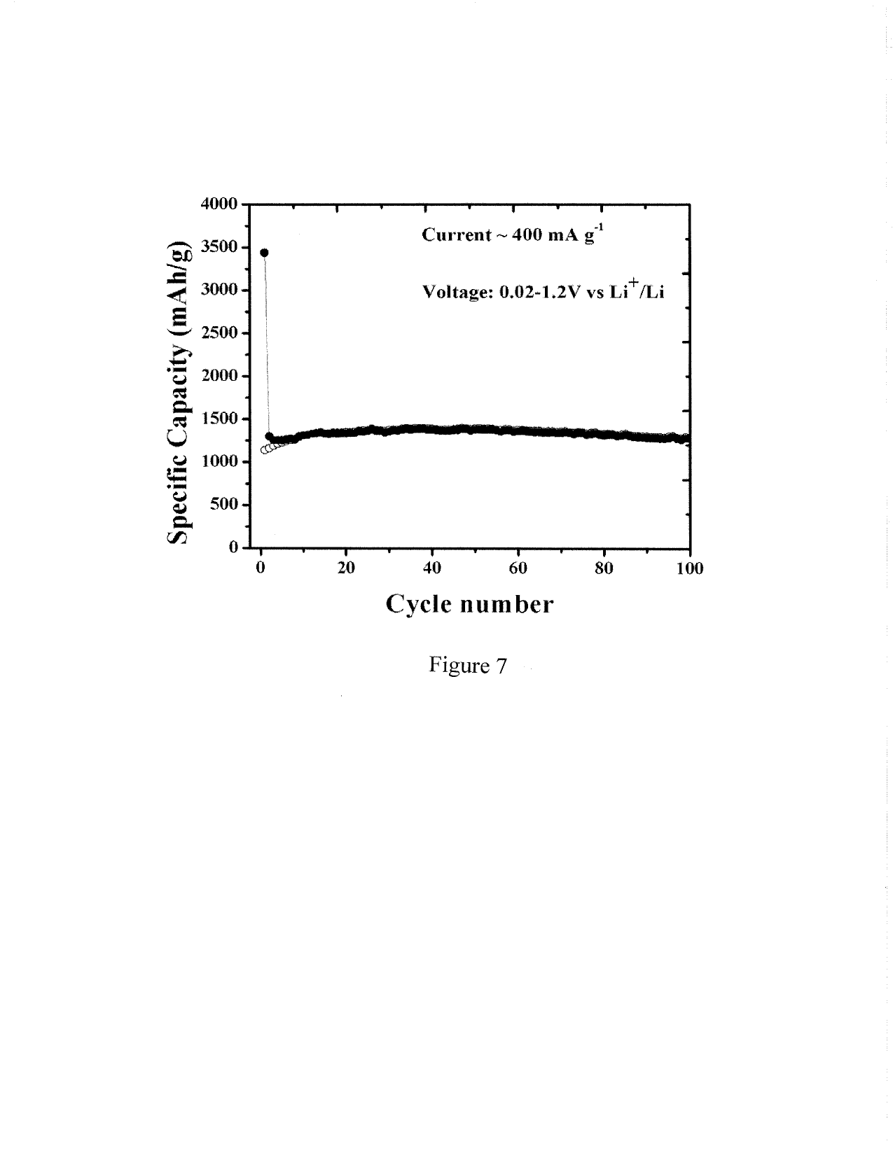

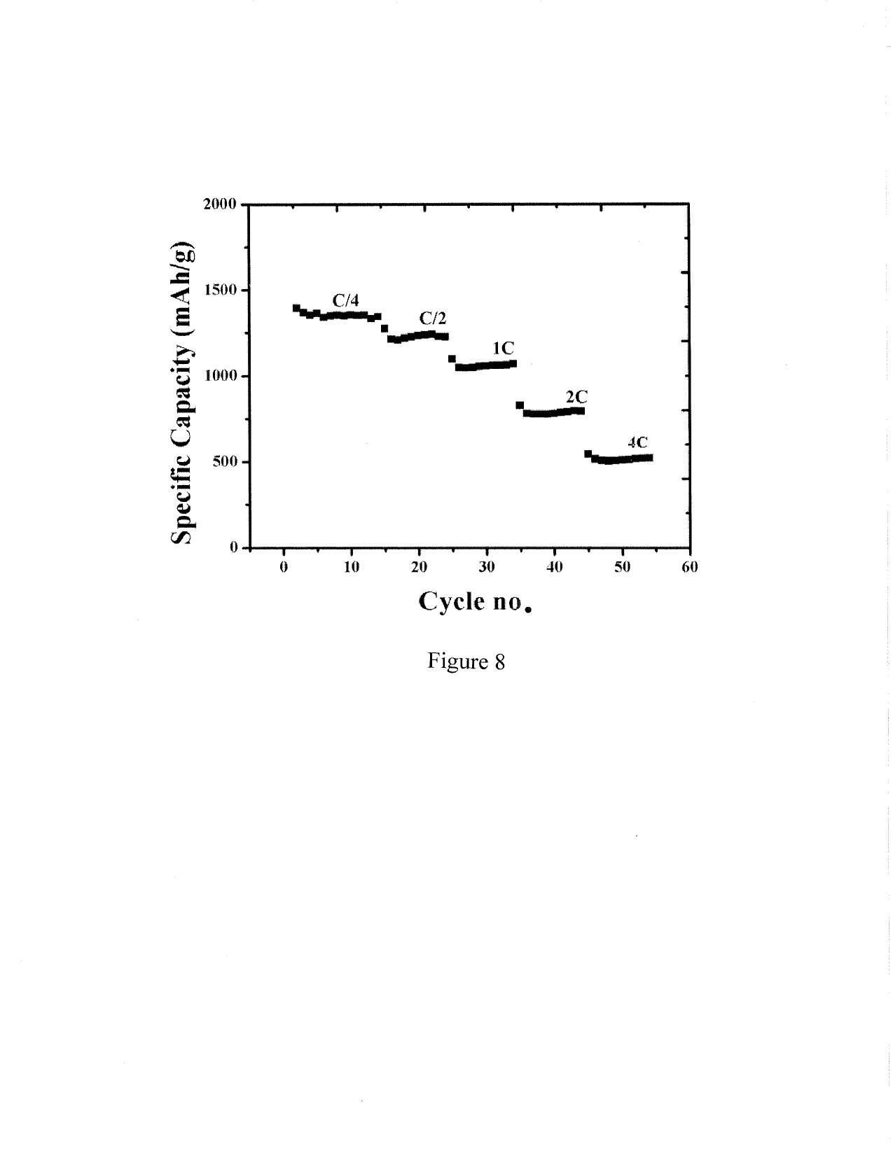

Studies on stability performance of the deposited films were done by cycling at 400 mA g⁻¹ between 1.2 V to 0.02 V vs. Li⁺/Li. A reversible capacity of ˜1300 mAh g⁻¹ was obtained for 100 cycles as shown in FIG. 7. The columbic efficiency varied from 94% to 98% from 2^{nd} to 5^{th} cycle, after which it improved and remained close to 99.9% for the remainder of the cycles. A fade rate of approximately 0.016% per cycle was observed which resulted in a capacity of approximately 1260 mA g⁻¹ at the end of 100^{th} cycle. Rate capability tests were conducted on a similar electrode for increasing current densities. FIG. 8 shows the capacity plots for 0.25 C, 0.5 C, 1 C, 2 C and 4 C rates. Negligible capacity loss was observed when the rate was increased from 0.25 C to 0.5 C. This, however, decreased progressively with further increase in current density and a capacity of approximately 520 mAh g⁻¹ was obtained at the 4 C rate. The decrease in capacity at higher rates could be attributed to the relatively low electronic conductivity of amorphous silicon. Nevertheless, there wasn't any noticeable capacity fade observed for a given rate/current density.

To understand the effect of cycling on the morphology of the deposited films, the electrodes were analyzed after cycling using SEM. At the end of the 100^{th} cycle, the electrode was transferred to a glove box, where it was carefully opened and rinsed in ethylene carbonate (EC) to dissolve the electrolyte. The electrode was left to dry in the glove box until all the EC evaporated, following which it was immediately stored in an airtight vial and transferred to the SEM chamber. The morphology of the film at the end of the 100^{th} cycle was observed. In comparison to the material corresponding to FIG. 4, the film appeared to have developed some pores upon cycling, but upon careful observation, these regions where the pores begin to form, actually looked like pits of varying depths. Without intending to be bound by any particular theory, it was speculated that the pits were formed due to eroding of the film upon dissolution of silicon in the electrolyte. Aside from the formation of pores, the silicon islands appeared to have maintained the morphology and island size even after 100 cycles of charge and discharge which is well supported from the excellent capacity retention of the film.

Impedance studies were performed at the end of complete charge for various cycles. The impedance spectra indicated a suppressed semi-circle and a straight line at approximately 45° to the Z (real) axis. The semi-circle was due to the charge transfer resistance offered by the surface of the deposited film while the straight line corresponded to the diffusion of lithium ions through the film. The spectra collected at the end of various cycles almost coincided with each other, without significant change in the shape with the extent of cycling. This showed that the deposited film was quite stable with no compositional changes occurring.

### Results

Electro-reduction of SiCl₄ to silicon was achieved at a cathodic potential of approximately 1.6 V vs. Pt.QRE on copper substrates from a PC based solvent. Galvanostatic reduction at a current density of −1 mA cm⁻² yielded greenish-yellow film and was mainly comprised of silicon, carbon and oxygen. Raman spectra obtained from the deposition region showed a broad peak of 485 cm⁻¹ which indicated that the deposited films were amorphous. Islands of silicon with mud crack type morphology were observed by SEM, which, after cycling, developed pits and pores on these islands. The deposited films showed a reversible capacity of approximately 1300 mAh g⁻¹ when cycled at a current density of 400 mAh g⁻¹ between the voltage 1.2 to 0.02 V vs. Li⁺/Li. Columbic efficiencies more than 99.5% and a fade rate of less than 0.16% per cycle were obtained for up to 100 cycles of charge/discharge. The films also showed good rate capability performance conducted at 0.25 C, 0.5 C, 1 C, 2 C and 4 C rates resulting in a capacity of approximately 520 mAh g⁻¹ for 4 C rate. Impedance studies conducted at the end of charge after 1, 2, 5, 10, 50 and 100 cycles showed that the charge transfer resistance did not vary with the cycle number, which may be correlated to the excellent long term cyclability obtained for 100 cycles.

### SUMMARY

Amorphous thin films of silicon were synthesized on copper current carrier by electro-reduction of SiCl₄ from PC based solvent. Raman spectra indicated the presence of mostly amorphous silicon on the surface along with some amount of nanocrystalline silicon. A high reversible capacity of approximately 1300 mAh g⁻¹ with excellent columbic efficiency (>99.5%) was achieved from the deposited films cycled at 400 mA g⁻¹. Further, excellent cyclability was observed for over 100 cyles with a fade rate of 0.16%/cycle.

### Example 5

### Extended Electroplating

In order to improve the active material loading density of amorphous silicon films, electroplating was performed for extended periods of time, e.g., from 2 hours to 6 hours. The electrolyte utilized for the deposition was composed of 0.5 M of SiCl₄ and 0.1 M of tetrabutylammonium chloride (TBACl) in propylene carbonate solvent (PC). A three-electrode cell was employed for the deposition process with copper foil having approximately 1 cm² area as the working electrode and Pt foil having approximately 2 cm² area and Pt wire as the reference electrode. Fresh electrolyte from 20-30 ml was used for each of the deposition processes. A constant current density of −1 mA/cm² was applied to the working electrode for various time periods from 1 hour to 6 hours to electroplate the amorphous silicon on the copper foil.

The films obtained with the use of lower deposition times, such as 2 hours and 3 hours, were found to be more uniform and stable compared to the films obtained with higher deposition times which peeled off upon washing with acetone. Further, at higher deposition times, discoloration of the electrolyte was observed which may have been due to the degradation of the PC or the supporting TBACl. The films obtained with 3 hours of deposition time were observed to be more uniform and did not peel off during a washing step with acetone.

Electrochemical characterization was performed on the films obtained with 3 hours of deposition time in a half cell configuration using Li foil as a counter electrode. A current density of 400 mA/g was applied between 0.02 to 1.2 V vs. Li⁺/Li. The results of the charge-discharge cycles of the amorphous silicon films obtained by electroplating for 3 hours demonstrated a very high first cycle discharge capacity, i.e., near to 3000 mAh/g, followed by a significant irreversible loss (i.e., 65%) similar to those achieved for films obtained with 1 hour deposition time. After the irreversible loss, a stable reversible capacity of 1000 mAh/g was observed for 80 cycles. Without intending to be bound by any particular theory, it was believed that the slight increase in capacity with the number of cycles may be attributed to the activation of the silicon sites which were initially not alloyed by lithium.

Whereas particular embodiments of the invention have been described herein for purposes of illustration, it will be evident to those skilled in the art that numerous variations of the details may be made without departing from the invention as set forth in the appended claims.

What is claimed is:

1. An anode composite, comprising:
a substrate having a surface; and
a coating electrolytically deposited directly onto said surface of said substrate, the coating comprising amorphous silicon which originates from a silicon-containing composition comprising silicon halide and solvent.

2. The composite of claim 1, wherein the silicon halide is selected from the group consisting of silicon tetrahydrochloride, silicon chloride hydride, silicon tetrabromide, silicon tetraiodide, and mixtures thereof.

3. The composite of claim 1, wherein the solvent is selected from the group consisting of propylene carbonate, silicon tetrachloride, acetronitrile, tetrahydrofuran, and mixtures thereof.

4. The composite of claim 1, wherein the substrate is selected from the group consisting of copper, nickel, platinum, silver, quartz, gold, stainless steel, tantalum, titanium and mixtures thereof.

5. The composite of claim 1, wherein the substrate is a current carrier.

6. The composite of claim 1, wherein the silicon-containing composition further comprises a supporting electrolyte.

7. The composite of claim 6, wherein the supporting electrolyte is selected from the group consisting of tetraethylammonium chloride, tetrabutylammonium chloride, tetrabutylammonium perchlorate, and mixtures thereof.

8. The composite of claim 1, wherein the coating is in the form of a film.

9. The composite of claim 1, wherein the coating further comprises carbon.

10. The composite of claim 9, wherein the carbon is selected from the group consisting of carbon nanotubes, graphene, elemental carbon and mixtures thereof.

11. The composite of claim 1, wherein the coating further comprises silicon selected from the group consisting of crystalline silicon, nanocrystalline silicon and mixtures thereof.

12. A silicon-containing composition for electrolytical deposition of amorphous silicon therefrom onto a surface of a substrate, comprising:
silicon halide;
solvent; and
supporting electrolyte,
wherein said composition provides an electrical conductivity to reduce said silicon halide upon passing an electrolyzing current through said composition.

13. The composition of claim 12, wherein the amorphous silicon originating from said composition is electrolytically deposited on the surface of the substrate by a method, comprising:
obtaining the substrate having the surface;
preparing the silicon-containing composition which comprises:
the silicon halide;
the solvent; and
the supporting electrolyte;
employing the silicon-containing composition as a solute in an electrolytic deposition, and
forming a coating comprising the amorphous silicon on said surface of said substrate.

14. The composition of claim 13 wherein said coating is in the form of a film.

15. The composite of claim 1, wherein said composite is prepared by a method, comprising:
obtaining the substrate having the surface;
preparing the silicon-containing composition which comprises:
the silicon halide; and
the solvent;
employing the silicon-containing composition as a solute in an electrolytic deposition; and
forming the coating comprising the amorphous silicon on said surface of said substrate.

16. A method of preparing an anode, comprising:
obtaining a substrate having a surface;
preparing a silicon-containing composition which comprises:
silicon halide; and
solvent;
employing the silicon-containing composition as a solute in an electrolytic deposition; and
forming a coating containing amorphous silicon on said surface of said substrate.

17. An electrode comprising the anode composite of claim 1.

18. A rechargeable lithium-ion battery comprising the anode composite of claim 1.

19. The electrode of claim 17, wherein there is an absence of material selected from the group consisting of binders, conducting agents, and mixtures thereof.
